(19) United States
(12) Patent Application Publication
(10) Pub. No.: US 2011/0308409 A1
(43) Pub. Date: Dec. 22, 2011

(54) BEARING ASSEMBLY AND CORRESPONDING INKING OR WETTING UNIT

(75) Inventors: Patrick Menu, Breuil le Vert (FR); Christophe Noiret, Saint Leu D'Esseurent (FR); Philippe Cousin, Royacourt (FR)

(73) Assignee: GOSS INTERNATIONAL MONTATAIRE SA, Montataire (FR)

(21) Appl. No.: 13/141,744

(22) PCT Filed: Dec. 23, 2009
(86) PCT No.: PCT/FR2009/052684

§ 371 Date: Sep. 6, 2011

(30) Foreign Application Priority Data
Dec. 24, 2008 (FR) 0859078

(51) Int. Cl. B41F 1/46; F16C 13/00; F16C 31/04

(52) U.S. Cl. 101/348; 384/57; 492/47

(57) ABSTRACT

A bearing assembly for an axially mobile cylinder in a printing press is provided. The bearing assembly includes an endpiece adapted so as to be mounted on a frame of the press and defining a central axis and a bearing arrangement for bearing a cylinder on the endpiece in rotation about the central axis and in translation along the central axis. The bearing arrangement includes a first bearing which is a radial bearing, notably an exclusively radial roller or needle bearing, and a second bearing which is either an axial/radial combined bearing or an only axial bearing. The second bearing is adapted so as to be fixed or attached with respect to the cylinder and connected to the endpiece via an axial spring with elasticity along the central axis. The second bearing is axially mobile with respect to the endpiece.

The present invention relates to a bearing assembly for an axially mobile cylinder in a printing press.

### BACKGROUND OF THE INVENTION

A touching cylinder is known from document DE-U-86 30 456, which is mobile in rotation and axially mobile in a frame of a printing press. The cylinder includes side journals through which it is mounted on a radial needle roller bearing and an axial/radial ball bearing. The mounting of the cylinder is very complicated, and because of the very large mass of the cylinder, the device cannot be used at great speeds. Indeed, the eigenfrequency of the assembly is in the ranges of excitation frequencies which occur during operation of the press.

Other devices for bearing a cylinder with axial and rotary mobility are described in U.S. Pat. No. 6,868,784 and U.S. Pat. No. 5,713,284. These devices refer to the mounting of a hollow cylinder on a continuous shaft, and are also complicated.

### SUMMARY OF THE INVENTION

The present invention includes a device with which an axially mobile cylinder may be mounted on a frame of a printing press, and this in a particularly simple way and with which eigenfrequencies may be obtained which are located outside the excitation frequencies encountered during operation of the press at high speeds (for example ranging up to 70,000 copies per hour).

A bearing assembly is provided that includes
a first bearing which is a radial bearing, notably an exclusively radial roller or needle bearing; and
a second bearing which is either a combined axial/radial bearing or an axial bearing alone, and in that

the second bearing is adapted so as to be fixed with respect to the cylinder and connected to the endpiece via an axial spring with elasticity along the central axis; and
the second bearing is axially mobile with respect to the endpiece.

According to particular embodiments, the invention may include one or more of the following features:
the endpiece includes a clamp for attachment to the frame and the first bearing is closer to the attachment clamp than the second bearing, as considered in the direction of the central axis;
the axial spring is positioned coaxially with the central axis and/or axially overlaps at least one of the first and second bearings;
the axial spring has a radial dimension less than an inner diameter of at least one of the bearings;
the second bearing includes an inner bearing ring and the assembly includes a guide for axially guiding the inner bearing ring with respect to the endpiece;
the assembly includes an intermediate sleeve into which are inserted:
an outer bearing ring of the second bearing; and
an outer bearing ring of the first bearing and the intermediate sleeve is adapted so as to be inserted into the cylinder and fixed or attached to the latter;
the first bearing is a bearing having an outer track, an inner track and bearing rolling bodies, the inner track being a cylindrical surface of the endpiece; and
the second bearing and the first bearing have outer bearing rings, and the outer diameters of the outer bearing rings are identical, and, if need be, identical with an inner surface of the sleeve.

A cylinder assembly is also provided including a cylinder defining a central axis, characterized that it includes at least one bearing assembly as defined earlier, and preferably two identical bearing assemblies, each bearing assembly being connected to one of the ends of the cylinder.

The cylinder assembly may include one or more of the following features:
the bearing assembly is a bearing assembly as defined above, the intermediate sleeve has an outer surface in contact with an inner surface of the base body of the cylinder, and the inner surface extends over the whole axial length of the base body of the cylinder;
the cylinder assembly includes abutment means limiting the axial displacement of the cylinder with respect to the endpiece;
the abutment means include two shoulders made in the endpiece and an abutment member cooperating with these shoulders and fixed or attached to the cylinder, preferably fixed or attached to the intermediate sleeve.

Finally, an inking or wetting unit of a printing press is also provided, characterized in that it includes a frame and at least one assembly as defined above.

### BRIEF SUMMARY OF THE DRAWINGS

The invention will be better understood upon reading the following description, only given as an example and made with reference to the appended drawings, wherein:

FIG. 1 is a schematic side view of a printing unit including a cylinder assembly according to the invention; and

FIG. 2 is an axial sectional view of a portion of a cylinder assembly according to the invention.

### DETAILED DESCRIPTION OF THE DRAWINGS

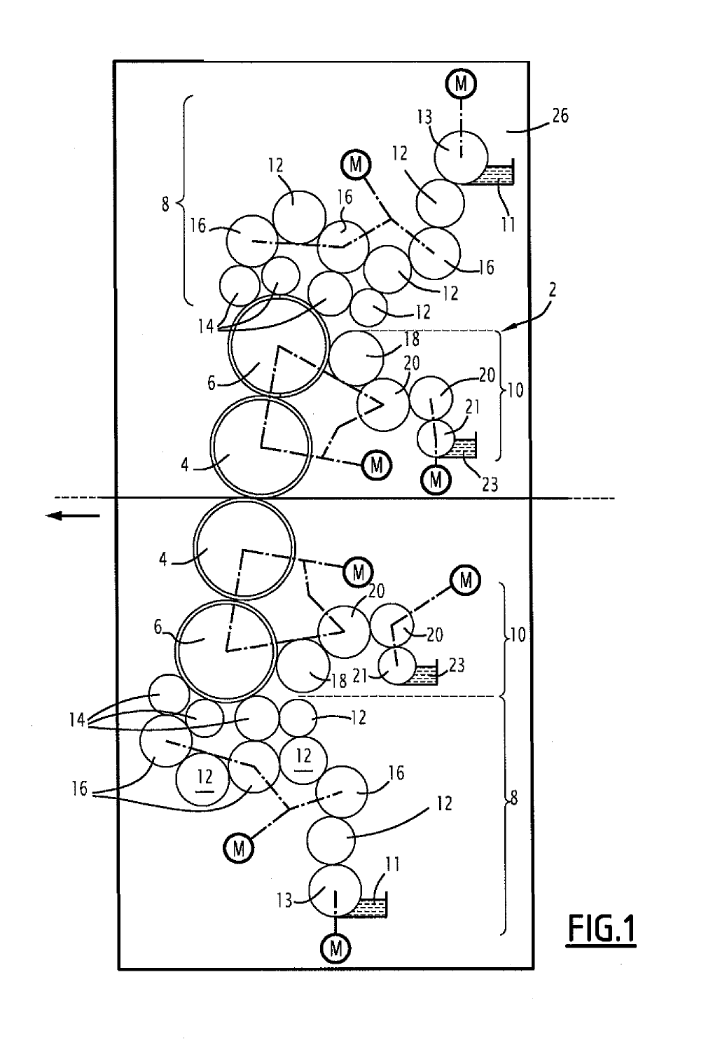

FIG. 1 schematically shows a printing unit of a tape offset printing press, designated by the general reference 2.

The printing unit 2 comprises a blanket cylinder 4, in this case two blanket cylinders, and at least one plate cylinder 6, in this case two plate cylinders.

The printing unit 2 further includes an inking unit 8 and a wetting unit 10.

The inking unit 8 is used for applying ink from an ink source 11 onto the plate cylinder.

The inking unit 8 includes a plurality of inking cylinders 12, an inking cylinder 13 in contact with the ink source 11. The inking unit 8 is provided with touching cylinders 14 for inking which are in contact with the plate cylinder 6. Intermediate cylinders 16 are interposed between the touching cylinders 14 for inking and the inking cylinders 12. The inking cylinders 12 are also called dispensing cylinders.

The wetting unit 10 includes a touching cylinder 18 for wetting which is in contact with the plate cylinder 6, and intermediate or dispensing cylinders 20.

The wetting unit 10 includes a source 23 of wetting liquid, such as water or a water/silicone emulsion.

The wetting unit 10 includes a wetting cylinder 21 in contact with the source 23 of wetting liquid.

The printing unit 2 further includes a frame 26 having two sides, one side of which is illustrated in FIG. 1, the other side having been omitted.

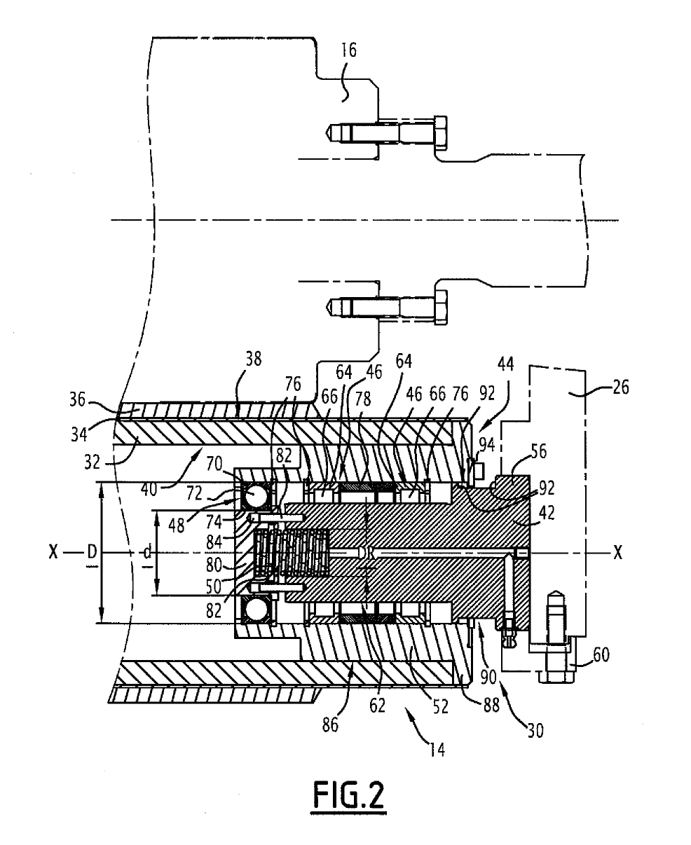

In FIG. 2, a portion of the printing unit 2 is illustrated schematically and in an axial sectional view. FIG. 2 illustrates a touching cylinder 14 and an intermediate cylinder 16 as well as an assembly for bearing the touching cylinder 14 designated by reference 30.

The bearing assembly 30 is an independent module of the touching cylinder 14 and of the frame 26 and may be handled as a single block without its components being detached, which facilitates its mounting.

The touching cylinder 14 consists of a base body 32, of an intermediate layer 34 and of a coating 36. The base body 32 defines a central axis X-X. In the following, the expressions “axially”, “radially” and “circumferentially” will be used with respect to the central axis X-X.

The base body 32 is a hollow cylinder and has an outer surface 38 and an inner surface 40. The inner surface 40 is a cylindrical surface with a circular section which extends over the whole axial length of the base body 32. The outer surface 38 is also a cylindrical surface with a circular section which extends over the whole axial length of the base body 32.

The base body 32 is advantageously made in steel, but may also be made either in aluminium, or in a composite material such as plastic material reinforced with carbon fibers.

The coating 36 is a protective layer for example a rubber coating. The coating 36 has an axial extent which is smaller than the axial extent of the base body 32.

The intermediate layer 34 is for example in rubber, in polymer or in another plastic material. The intermediate layer 34 has an axial extent greater than the axial extent of the base body 32.

The bearing assembly 30 includes an endpiece 42 which is mounted on the frame 26. The endpiece 42 is either fixedly mounted to the frame, either via an adapted mechanism for displacing the touching cylinder 14 between the non-print and print positions.

The bearing assembly 30 further includes means 44 for bearing the cylinder 14 on the endpiece 42. These bearing means 44 are adapted so as to allow rotation of the cylinder 14 about the central axis X-X and axial translation along this X-X axis.

The bearing means 44 include two radial bearings 46, in this case exclusively radial bearings, and an axial bearing 48. The axial bearing 48 is a ball bearing. In this case, the axial bearing 48 is an axial bearing alone but it may be an axial/radial bearing.

The bearing means 44 also include an axial spring 50 having elasticity along the central axis X-X.

The spring 50 in this case is a helical spring, the central axis of which is parallel to the axis X-X and is preferably coaxial with the latter.

The bearing means 44 include an intermediate sleeve 52 positioned between the radial 46 and axial 48 bearings and the cylinder 14.

The endpiece 42 includes an attachment flange or an attachment clamp 56 adapted for connecting the endpiece 42 to the frame 26. The attachment clamp 56 has a shape which mates a shape of a housing made in the frame 26. The attachment clamp 56 is fixed or attached in this housing via a screw and a clamp 60.

The endpiece 42 also includes a cylindrical supporting surface 62.

Preferably, the supporting surface 62 is made in a single piece with the endpiece 42, thereby reducing the number of components.

Each radial roller bearing 46 includes an outer ring 64 defining an outer bearing track, bearing bodies 66, in this case roller bearing cylinders and an inner bearing track. The inner bearing track is formed by the cylindrical surface 62. Alternatively, the inner bearing track may be formed by an inner bearing ring. Still alternatively, the bearing bodies 66 are needles.

The supporting surface 62, and accordingly the inner bearing track of the radial roller bearings 46 have an axial extent greater than the axial extent of the bearing bodies 66.

The axial bearing 48 includes an outer bearing ring 70, bearing roller bodies 72, in this case balls, and an inner bearing ring 74.

The bearing means 44 also include axial attachment means for the roller bearings 46, 48 with respect to the intermediate sleeve 52. These attachment means comprise a first slotted ring 76 engaged into a groove made in the sleeve 52 and axially attaching the outer ring 70. These attachment means also comprise a second and a third slotted ring 76 engaging into two grooves made in the sleeve 52 and axially attaching both outer rings 64 of the radial roller bearings 46. These axial attachment means also comprise a spacer 78 extending between the outer bearing rings 64.

Advantageously, the outer bearing ring 70 and the outer bearing rings 64 have identical outer diameters D. Also, the inner surface of the sleeve 52 has a same inner diameter except for the grooves receiving the slotted rings 76 and a shoulder for the outer ring 70, over the whole of its extent, which facilitates manufacturing and mounting of the sleeve 52 and roller bearings 46, 48.

Also, advantageously, said or each radial roller bearing 46 is axially closer to the attachment clamp 56 than the axial bearing 48.

The bearing means 44 comprise a support 80. The inner bearing ring 74 of the axial bearing 48 is positioned on the support 80. The support 80 and the endpiece 42 each include a cylindrical recess defining a housing 82 for the spring 50.

The outer diameter DR of the spring 50 is less than the inner diameters of the bearings 48 and 46. More specifically, the outer diameter DR of the spring 50 is less than the inner diameter d of the inner bearing ring 74.

Also, the spring 50 axially overlaps the axial bearing 48 and the radial roller bearing 46 which is the closest to the axial bearing 48. With these features, it is possible to design bearing means 44 with a small axial and radial extent for given loads.

The bearing means 44 also include means for axial guidance of the support 80 with respect to the endpiece 42. These guiding means comprise at least one pin 82 and one bore 84, the pin 82 and the bore 84 having axial mobility with respect to each other. The pin 82 is fixed or attached to the endpiece 42.

The intermediate sleeve 52 includes an outer cylindrical surface 86 mating the inner surface 40 of the base body 32 and a connecting clamp 88 having a diameter greater than that of the outer surface 86 and being applied on the front surface of the base body 32. The intermediate layer 34 extends axially on the clamp 88.

The intermediate layer 34 is present when the base body 32 is in a composite fiber material. This layer 34 protects the fibers and gives the possibility of avoiding infiltrations of liquid such as water, ink, wetting products, etc. between the base body 32 and the clamp 88.

The intermediate sleeve 52 is fixed or attached via the clamp 88 on the base body 32, for example by a screw not shown.

The bearing means 44 also include abutment means 90 adapted for limiting the axial displacement of the touching cylinder 14 with respect to the endpiece 42. These abutment means 90 include an annular groove forming two shoulders 92 made in the endpiece 42 and an abutment member 94 cooperating with the shoulders 92 in the axial extreme positions. The abutment member 94 is fixed or attached to the intermediate sleeve 52 and is a plate for example.

In FIG. 2, a single bearing assembly 30 and a single axial end of the touching cylinder 14 are illustrated. However, the printing unit 2 includes a second identical assembly 30 which connects the other end of the touching cylinder 14 to the side of the frame 26 not shown.

The assembly operates in the following way.

In the rest condition, the spring 50 pushes the touching cylinder 14 via the support 80, the axial bearing 48 and the sleeve 52, into an axial rest position.

Once the inking unit has started, the intermediate cylinder 16 is driven to and fro axially and in rotation. Via the friction between the intermediate cylinder 16 and the touching cylinder 14, the latter is also driven into rotation and follows the axial movement of the cylinder 16. The axial displacement of the touching cylinder 14 is limited by the abutment means 90 and the spring 50 is adapted so as to maintain weak axial forces acting on the abutments 92. During the axial displacement of the touching cylinder 14, the intermediate sleeve 52, the axial bearing 48, the support 80, the outer bearing rings 64 and the bearing bodies 66 move as a single block with the cylinder 14 with respect to the endpiece 42.

The mounting of the bearing assembly 30 is particularly simple and is carried out in the following way.

First of all, the axial bearing 48 is inserted into the intermediate sleeve 52. It is fixed or attached by the first slotted ring 76. Next, the support 80 is inserted into the inner bearing ring 74 of the bearing 48.

Subsequently, the spring 50 is positioned in the housing 82. Next the second slotted ring 76 is inserted into the corresponding groove. And then the first outer bearing ring 64, the spacer 78 and the second outer bearing ring 64 are successively inserted into the sleeve 52 and fixed or attached by the third slotted ring 76.

Finally, the abutment member 94 is fixed or attached by a screw onto the intermediate sleeve 52. The bearing assembly 30 may be handled by the abutment means 90, in the absence of the cylinder 14 and of the frame 26, as a single block, without it being untimely detached.

Also, the mounting of the different components 46, 48, 80, 78 in the intermediate sleeve 52 is carried out on a single side in the sleeve 52 and the bearing assembly 30 is inserted in this same direction into the cylinder 14. This also facilitates mounting and manufacturing.

The design of the bearing assembly 30 is particularly compact for given loads, and gives the possibility of locating the eigenfrequency outside the excitation frequencies generated by the printing unit even for high printing rates.

The invention has been described with reference to the touching cylinder 14 for inking and to the intermediate cylinder 16, but the touching cylinder 18 foe wetting is also mounted on the frame by means of two bearing assemblies 30.

Still alternatively, the bearing assembly includes a single radial roller bearing 46 or more than two radial roller bearings 46, having the aforementioned technical characteristics of the radial roller bearings 46.

The radial roller bearing 46 which is the closest to the endpiece 32 has an anti-cant role.

What is claimed is:

1-13. (canceled)

14. A bearing assembly for an axially mobile cylinder in a printing press, of the type comprising:
an endpiece adapted so as to be mounted on a frame of the press and defining a central axis;
a bearing arrangement for bearing a cylinder on the endpiece in rotation about the central axis and in translation along the central axis, the bearing arrangement including:
a first bearing, the first bearing being a radial bearing; and
a second bearing, the second bearing being an axial/radial combined bearing or an only axial bearing, the second bearing being adapted so as to be fixed or attached with respect to the cylinder and connected to the endpiece via an axial spring with elasticity along the central axis, the second bearing being axially mobile with respect to the endpiece.

15. The bearing assembly as recited in claim 14 wherein the first bearing is an exclusively radial roller or a needle bearing.

16. The bearing assembly as recited in claim 14 wherein the endpiece includes a clamp for attachment to the frame and the first bearing is closer to the attachment clamp than the second bearing as considered in the direction of the central axis.

17. The bearing assembly as recited in claim 14 wherein that the axial spring is at least one of positioned co-axially with the central axis and overlaps axially at least one of the first and second bearings.

18. The bearing assembly as recited in claim 17 wherein the axial spring has a radial dimension less than an inner diameter of at least one of the first and second bearings.

19. The bearing assembly as recited in claim 14 wherein the second bearing includes an inner bearing ring and the bearing arrangement further includes a guide for axial guidance of the inner bearing ring with respect to the endpiece.

20. The bearing assembly as recited in claim 14 wherein the bearing arrangement includes an intermediate sleeve, an outer bearing ring of the second bearing and an outer bearing ring of the first bearing being inserted in the intermediate sleeve, the intermediate sleeve being adapted so as to be inserted into the cylinder and fixed or attached to the cylinder.

21. The bearing assembly as recited in claim 20 wherein the outer diameters of the outer bearing rings of the second bearing and the first bearing are identical with an inner surface of the intermediate sleeve.

22. The bearing assembly as recited in claim 14 wherein the first bearing includes an outer track, an inner track and roller bearing bodies, the inner track being a cylindrical surface of the endpiece.

23. The bearing assembly as recited in claim 14 wherein the second bearing and the first bearing have outer bearing rings, the outer diameters of the outer bearing rings of the second bearing and the first bearing being identical.

24. A cylinder assembly comprising:
a cylinder defining a central axis; and
a bearing assembly, the bearing assembly including an endpiece adapted so as to be mounted on a frame of the press, the bearing assembly including a bearing arrangement for bearing the cylinder on the endpiece in rotation about the central axis and in translation along the central axis, the bearing arrangement including:
a first bearing, the first bearing being a radial bearing; and
a second bearing, the second bearing being an axial/radial combined bearing or an only axial bearing, the second bearing being adapted so as to be fixed or attached with respect to the cylinder and connected to the endpiece via an axial spring with elasticity along the central axis, the second bearing being axially mobile with respect to the endpiece.

25. The cylinder assembly recited in claim 24 further comprising a second bearing assembly identical to the bearing assembly, the bearing assembly being connected to one end of the cylinder and the second bearing assembly being connected to the other end of the cylinder.

26. The cylinder assembly recited in claim 24 wherein the bearing assembly includes an intermediate sleeve, an outer bearing ring of the second bearing and an outer bearing ring of the first bearing being inserted in the intermediate sleeve, the intermediate sleeve being adapted so as to be inserted into the cylinder and fixed or attached to the cylinder, the intermediate sleeve having an outer surface in contact with an inner surface of a base body of the cylinder, the inner surface of the base body extending over the whole axial length of the base body.

27. The cylinder assembly recited in claim 24 further comprising an abutment limiting the axial displacement of the cylinder relatively to the endpiece.

28. The cylinder assembly recited in claim 27 wherein the abutment include two shoulders made in the endpiece and an abutment member co-operating with these shoulders and fixed or attached to the cylinder.

29. The cylinder assembly recited in claim 28 wherein the abutment member is fixed or attached to the intermediate sleeve.

30. An inking or wetting unit of a printing press comprising:
a frame; and
a bearing assembly connected to the frame, the bearing assembly including an endpiece adapted so as to be mounted on a frame of the press, the bearing assembly including a bearing arrangement for bearing the cylinder on the endpiece in rotation about the central axis and in translation along the central axis, the bearing arrangement including:
a first bearing, the first bearing being a radial bearing; and
a second bearing, the second bearing being an axial/radial combined bearing or an only axial bearing, the second bearing being adapted so as to be fixed or attached with respect to the cylinder and connected to the endpiece via an axial spring with elasticity along the central axis,
the second bearing being axially mobile with respect to the endpiece.
